(19) United States
(12) Patent Application Publication
(10) Pub. No.: US 2013/0057390 A1
(43) Pub. Date: Mar. 7, 2013

(54) RADIO FREQUENCY IDENTIFICATION TAGS FOR USE IN EXTREME ENVIRONMENTS

(71) Applicants: David Watt, Newark, CA (US); Leon Fay, Stanford, CA (US); Jose Joseph, Palo Alto, CA (US); Karen Marie Nashold, San Francisco, CA (US); David Watters, Sunnyvale, CA (US)

(72) Inventors: David Watt, Newark, CA (US); Leon Fay, Stanford, CA (US); Jose Joseph, Palo Alto, CA (US); Karen Marie Nashold, San Francisco, CA (US); David Watters, Sunnyvale, CA (US)

(73) Assignee: SRI INTERNATIONAL, Menlo Park, CA (US)

(21) Appl. No.: 13/697,193

(22) PCT Filed: May 25, 2011
(86) PCT No.: PCT/US11/37838

§ 371 Date: Nov. 9, 2012

Related U.S. Application Data
(60) Provisional application No. 61/348,444, filed on May 26, 2010.

(51) Int. Cl. G06K 7/01; G06K 19/077; G01K 13/00; G06K 19/073

(52) U.S. Cl. 340/10.1; 235/492; 374/152; 374/E13.001

(57) ABSTRACT

A portable RFID (Radio Frequency Identification) tag includes one or more sensors. Each sensor measures a condition of an environment within which the RFID tag is disposed. Circuitry obtains data from measurements provided by each sensor. A transceiver modulates a radio frequency (RF) signal carrying the obtained data. An antenna, electrically coupled to the transceiver, transmits the RF signal. The circuitry, transceiver, and antenna are potted in their entirety in a thermosetting plastic epoxy for purposes of enduring extreme environmental conditions. The one or more sensors can include a temperature probe. A portion of this temperature probe can serve as the antenna.

### RELATED APPLICATION

This utility application claims the benefit of U.S. Provisional Application No. 61/348,444, filed on May 26, 2010, titled “Radio Frequency Identification Tags for use in Extreme Environments,” the entirety of which provisional application is incorporated by reference herein.

### FIELD OF THE INVENTION

The invention relates generally to radio frequency identification (RFID). More specifically, the invention relates to RFID tags adapted for use in extreme environments.

### BACKGROUND

Steam sterilization is a process for killing microbial organisms in, for example, packs of medical instruments. The process of steam sterilization generally involves placing items undergoing sterilization into a chamber (autoclave) and subjecting them to steam at high temperature and pressure for a predetermined period. Often packed within porous materials, these items sit within the chamber in close proximity of each other. To ensure penetration of the steam into the materials, current steam sterilization processes typically use conservative cycle times. Although they generally make the sterilization process reliable, conservative cycle times lengthen the process, which can be a critical factor in the efficiency of a health care facility.

Moreover, steam sterilization systems require verification to ensure that the probability of microorganisms surviving sterilization is extremely small. For purposes of verification, chemical and biological indicators are state of the art for production sterilization. Placed inside the pack with the item undergoing sterilization, these indicators give a visual indication of when sterilization is completed, for example, a change in color on a paper strip. To inspect these indicators, though, someone needs to unwrap the pack. Further, although they serve to show that the sterilization conditions achieved a particular threshold, the chemical and biological indicators do not provide any actual measurements of temperature, pressure, humidity over the duration of the sterilization process.

Preferably, verification should be possible during the sterilization cycle or shortly thereafter. Often, however, sterilized packs are stored for a while, and later transported to their point of use, for example, in an operating room with a waiting patient. Rejection of the pack at that time would be wasteful of time and money. Such are the pitfalls of a steam sterilization process that relies on after-the-fact verification. The chemical and biological indicators also offer no mechanisms for tracking movement of the packs or for assisting in the prevention of mistakes associated with sending packs to the wrong destination.

Additionally, regulatory agencies are requiring more redundancy and traceability in the sterilization of items, such as medical instruments. At present, sterilization systems typically keep a record of the sterilization parameters and provide a printed receipt to the operator. Audit trails are therefore difficult to automate and costly to establish and maintain.

### SUMMARY

In one aspect, the invention features a portable RFID (Radio Frequency Identification) tag comprising one or more sensors. Each sensor measures a condition of an environment within which the RFID tag is disposed. The RFID tag further comprises circuitry that obtains data from measurements provided by each sensor, a transceiver that modulates a radio frequency (RF) signal carrying the obtained data, and an antenna, electrically coupled to the transceiver, that transmits the RF signal. The circuitry, transceiver, and antenna are potted in their entirety in a thermosetting plastic epoxy.

In another aspect, the invention features a portable RFID tag comprising a temperature probe measuring temperature in an environment within which the RFID tag is disposed, circuitry in communication with the temperature probe to obtain temperature data from measurements provided by the temperature probe, and a transceiver modulating a radio frequency (RF) signal carrying the temperature data obtained by the circuitry. The transceiver is in communication with the temperature probe to use a portion of the temperature probe as an antenna for transmitting the RF signal carrying the temperature data.

In another aspect, the invention features an environment monitoring system comprising, a chamber providing an enclosed environment and a plurality of portable RFID (Radio Frequency Identification) tags disposed within the enclosed environment provided by the chamber. Each RFID tag comprises one or more sensors, each sensor measuring a condition of an environment within which the RFID tag is disposed, circuitry obtaining data from measurements provided by each sensor, a transceiver modulating a radio frequency (RF) signal carrying the obtained data, and an antenna, electrically coupled to the transceiver, transmitting the RF signal. The circuitry, transceiver, and antenna are potted in their entirety in a thermosetting plastic epoxy. The system further comprises a transceiver module disposed outside of the chamber in communication with each of the RFID tags within the chamber to transmit thereto commands and to receive therefrom, in response to the commands, the transmitted RF signals carrying the obtained data.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram of an embodiment of an environment monitoring system including a host device in communication, through a transceiver module, with a plurality of RFID tags disposed in an environment.

FIG. 2 is a functional block diagram of one embodiment of the transceiver module.

FIG. 3A and FIG. 3B are a flow diagram of an embodiment of a process for operating the transceiver module.

FIG. 4 is a functional block diagram of one embodiment of an RFID tag.

FIG. 5A and FIG. 5B is a flow diagram for one embodiment of a process performed by the RFID tag during normal operation.

FIG. 6 is an isometric view of one embodiment of an RFID tag housing.

FIG. 7 is a top view of the base of the RFID tag housing, without the lid and temperature probe.

FIG. 8 is an isometric view of one embodiment of the temperature probe.

FIG. 9 is a cross-sectional view of the RFID tag.

### DETAILED DESCRIPTION

Extreme environment monitoring systems, as described herein, include a transceiver module in communication with a plurality of battery-powered environment monitoring units, referred to interchangeably as RFID (Radio Frequency Identification) tags and as steam tags. These RFID tags can withstand repeated exposure to harsh environments, and can have its sensor measurements monitored wirelessly, by a host device communicating through the transceiver module, in real time and with high reliability. The epoxy housing (and optional outer plastic housing) of the RFID tag, designed to reduce cost, protects the RFID tag's internals, in particular, its electronic components, against the ingress of the environmental elements, such as steam.

A transceiver in the RFID tag operates across a wide range of temperatures, requiring almost no power to operate, and, thus, enabling the other electronic components of the RFID tag to enter and remain in a low-power sleep mode. This sleep mode extends the life of the RFID tag's battery. While in the low-power sleep mode, the RFID tag consumes only microwatts of power, until awakened by the transceiver in order to acquire and transmit sensor data to the host device. The transceiver of the RFID tag includes an active transmitter and either a semi-passive or an active receiver. The embodiment of RFID tag with the semi-passive receiver consumes little power because most of the functionality of the semi-passive receiver is performed by passive components. The embodiment of RFID tag with the active receiver consumes more power than that with the semi-passive receiver, but average power consumption is managed by operating the active receiver at a low duty cycle (1% or less), meaning that the active receiver is in sleep mode drawing almost no power approximately 99% of the time.

A robust antenna disposed near the RFID tags, typically disposed within the same harsh environment within which the RFID tags are exposed, such as in a sterilization chamber, allows the RFID tag to use a low-power transmitter for transmitting the sensor data. The RFID tags communicate with the robust antenna, upon request or in real-time. The relatively short distance between each given RFID tag and the internal antenna enhances reliable communications therebetween; alternatively, communication can be achieved with an external antenna, albeit potentially detrimentally to high-frequency radiation. In addition, to verify packet delivery, each RFID tag and the transceiver module exchange communications in accordance with a reliable protocol.

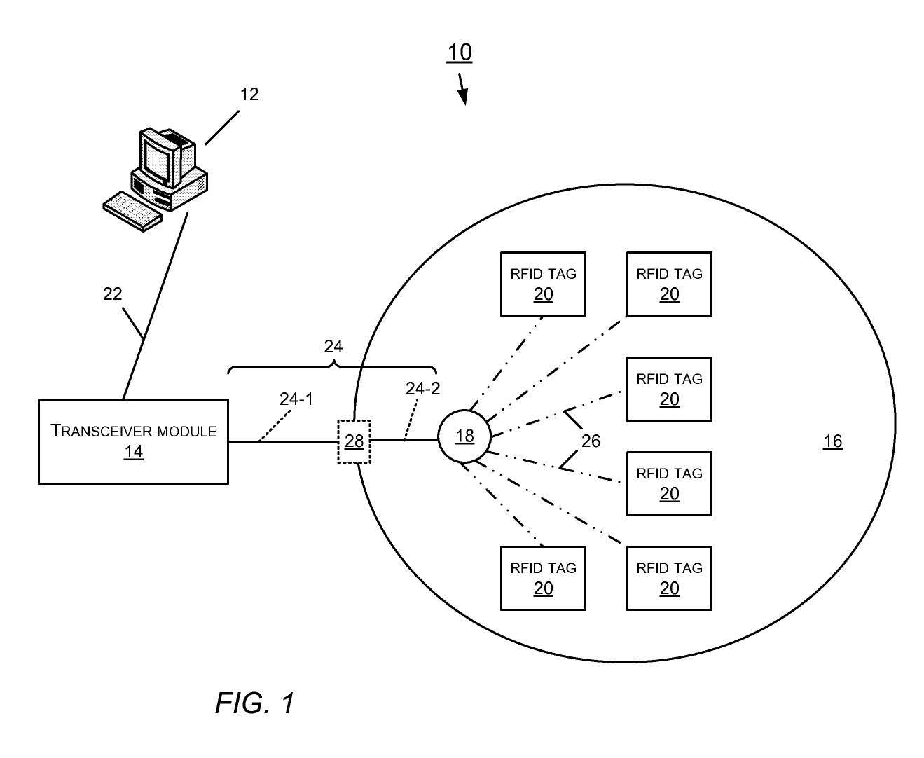

FIG. 1 shows an embodiment of an environment monitoring system 10, including a host device 12, a transceiver module 14, and the environment 16 being monitored. Disposed within the environment 16 is an antenna 18 and a plurality of environment monitoring units 20 (the aforementioned RFID tags), for example, as many as 50 of such RFID tags. The host device 12 is in communication with the transceiver module 14 over a communication link 22 (e.g., an RS-232 or a USB (Universal Serial Bus) serial link), and the transceiver module 14 is in communication with the antenna 18 over a communication link 24. Each of the RFID tags 20 is in wireless communication with the antenna 18 over a radio communication link 26. In one embodiment, the radio communication link 26 is a UHF (ultra high frequency) link.

The host device 12 is a processor-based computing device with memory (not shown) that stores computer-readable program code including a software application for communicating with the transceiver module 14. Example implementations of the host device 12 include, but are not limited to, a personal computer (PC), Macintosh® computer, MacBook® computer, a workstation, a kiosk, laptop computer, server system, hand-held device, such as a personal digital assistant (PDA), a mobile or cellular phone, and network terminal. The software application produces a user interface (e.g., text, graphical) through which the user can interact with the transceiver module 14 and thereby communicate with the RFID tags 20, for example, to select and enter commands, such as changes to settings of the RFID tag, and to receive responses from the RFID tags 20, for example, retrieved sensor data.

The transceiver module 14, generally, is an independent hardware unit that operates as a bridge between each RFID tag 20 and the host device 12, receiving commands from the host device 12 over the communication link 22, issuing these commands to a given RFID tag 20 over the communication link 24 and radio link 26, listening for responses from the given RFID tag 20 over the radio link 26 and communication link 24, and forwarding these responses to the host device 12 over the communication link 22. Any packets received by the transceiver module from an RFID tag are forwarded to the software application running on the host device in their entirety. Additionally, all transceiver module messages that need to be printed to the screen of the host device in order for the user to see (for example, “Packet received”) are passed to the host device over this communication link 22.

In one embodiment, the environment 16 is an enclosed steam sterilization chamber within which a controlled harsh environment is produced, for example, using temperature, pressure, chemicals, humidity, or any combination thereof. Other examples of enclosures or chambers within which the principles described herein may be practiced include, but are not limited to, semiconductor and glass coating process chambers.

Typically, a steam sterilization chamber is a sealed enclosure that can impede communication between the transceiver module 14 external to the chamber and the antenna 18 within the chamber. For such an embodiment, the chamber has a sealed RF coax coupler 28 in its frame. The transceiver module 14 is in communication with this RF coax coupler 28 over one wired communication link 24-1 that is external to the chamber, and the antenna 18 is coupled to the RF coax coupler 28 over another wired communication link 24-2 that is internal the chamber. The communication links 24-1, 24-2 ensure reliable transmission of signals between the transceiver module 14 and antenna 18. In addition, having the antenna 18 within the chamber, coupled to the transceiver module, advantageously avoids having the RFID tags 20 transmit radio signals through the chamber's walls to the external transceiver module, an action that would drain power from the tag's battery and severely reduce the RFID tag's useful life. This antenna 18 can withstand high temperatures within the chamber and resist detuning from nearby metal objects. In one embodiment, the antenna 18 is implemented using an Antenna Factor 916 MHz Splatch Antenna produced by Antenna Factor™ of Merlin, Oreg. For purposes of enduring extreme environmental conditions, the antenna can be fully potted using epoxy materials described below in connection with potting the RFID tags.

An enclosed chamber is but one example of an environment that can be monitored; the described principles may also be practiced in less controlled or uncontrolled environments, examples of which include, but are not limited to, oil wells, chemical process refineries, kilns, restaurant dishwashers, industrial laundries, glass coating processes, food service processes, pipelines, geothermal energy systems, tire vulcanizing systems, pharmaceutical manufacturing processes, and semiconductor manufacturing processes.

Generally, each RFID tag 20 is a hardware unit for sensing certain the physical environmental conditions inside the environment 16 within proximity of that RFID tag (e.g., temperature, pressure, and humidity), storing measured sensor data in memory, and sending this sensor data to the transceiver module 14 through radio transmission to the antenna 18. In general, the sensor data are stored temporarily, at least long enough to resend in the event the transceiver module 14 indicates that the data have not been received.

Accordingly, the RFID tag has two data links, a first link (also called the uplink) from the RFID tag to the transceiver module and a second link (called the downlink) from the transceiver module to the RFID tag. In one embodiment, the downlink and the uplink are both modulated with On-Off Keying (OOK), with the downlink using near field communication at 125 kHz and the uplink using the UHF band. Alternatively, Frequency Shift Keying (FSK) can be used for the uplink

In another embodiment, the RFID tag employs UHF in both the uplink and the downlink. Various parts of the UHF band are appropriate for different parts of the world. For example, frequency bands at approximately 866 MHz and 915 MHz satisfy regulatory requirements in the European Union and in the United States, respectively. Slightly different frequency bands are required for other countries; for example, approximately 842 MHZ or 922 MHz for China, 955 MHz for Japan, 918 MHz for Korea, 919 MHz for the Philippines, 925 MHz for Taiwan, and 922 MHz for Thailand. Transceivers with wide enough bandwidths, or dual bandwidths, can be implemented for use worldwide.

In one embodiment of the environmental monitoring system 10, reliable operation requires that all RFID tags 20 deployed within the environment 16 and no tags external to the environment 16 be associated with the environment monitoring system. Having tags respond only to their associated transceiver module facilitates the process. One technique includes using low frequency, near-field communication at 125 kHz between the transceiver module 14 and the tags 20. By design, the distanced reached by this type of communication link is short, and only nearby tags respond. As another technique, the transceiver module 14 makes several transmissions at steadily increasing power levels. Gradually, an increasing number of tags respond until the total number of responding tags, known in advance, has been reached. An environment that largely prevents electromagnetic leakage, such as a steam sterilizer, can increase the effectiveness of both techniques. The metal exterior of the steam sterilizer may make the internal tags easier to detect than any external tags on the outside. The transceiver module can provide audible or visual feedback as RFID tags are registered.

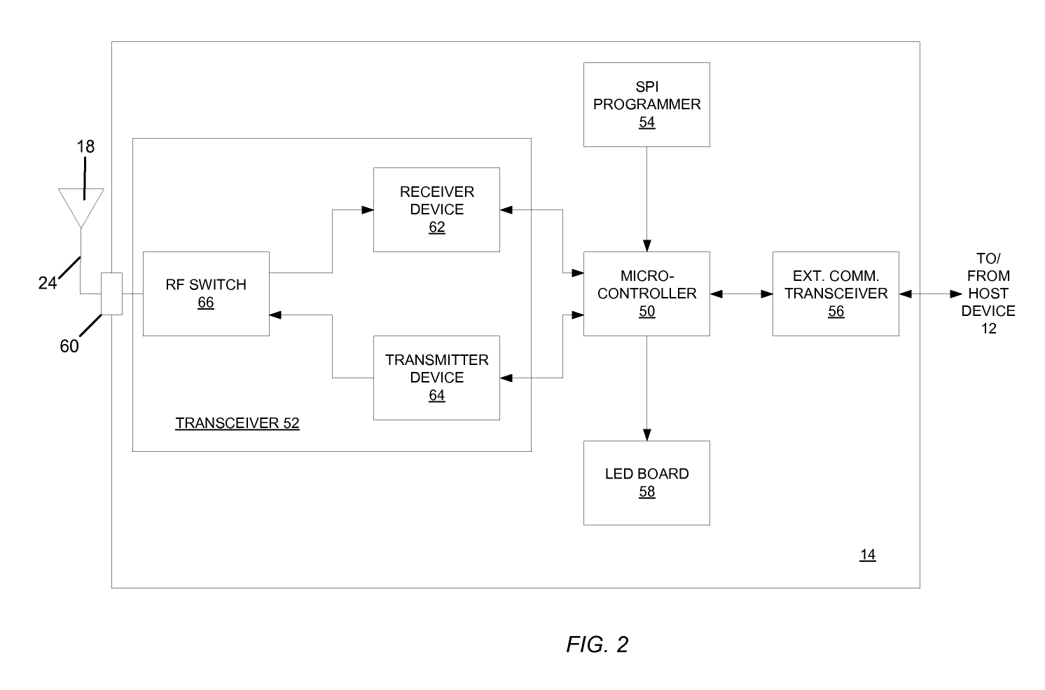

FIG. 2 shows a functional block diagram of one embodiment of the transceiver module 14, which includes a microcontroller 50 in communication with a radio transceiver 52, an SPI (serial peripheral interface) programmer 54, an external communication transceiver 56, and an LED board 58. The transceiver module 14 also includes a connector 60 that couples to the antenna 18 over the communication link 24 (e.g., a 50-ohm gold SMA (SubMinutiae A)). The transceiver module 14 can be powered either from a battery or from a DC power supply. An on board switching power converter creates the necessary voltages.

The microcontroller 50 is in communication with the radio transceiver 52 for communicating with the RFID tags 20 and with the external communication transceiver 56 for communicating with the host device 12. The microcontroller 50 can be implemented using an ATMEGA644, produced by Atmel of San Jose, Calif. The microcontroller 50 can be programmed with an SPI or JTAG (Joint Test Action Group) programmer. A quartz crystal oscillator provides a clock for the microcontroller 50 and a time reference for the entire system.

The radio transceiver 52 includes a receiver device 62 and transmitter device 64, each in communication with an RF switch 66 that switches between transmit and receive operation. The RF switch 66 enables shared use of a single antenna 18. In one embodiment, the transmitter device 64 is implemented using a Si4032 and the receiver device 62 is implemented using a Si4322, both from Silicon Labs, Austin, Tex. These particular receivers/transmitters operate in the UHF band.

The LED board 58 is used to provide illumination to the transceiver module. This feature allows different colored LEDs to indicate the status of the transceiver module: for example, sending, receiving, or failure.

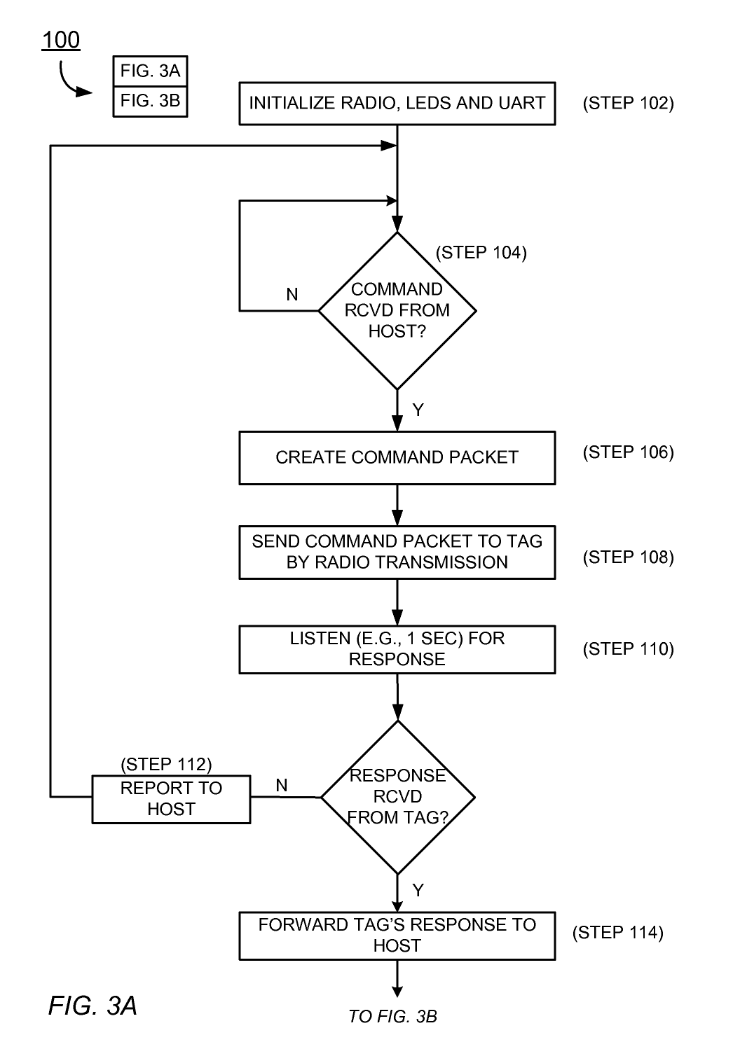

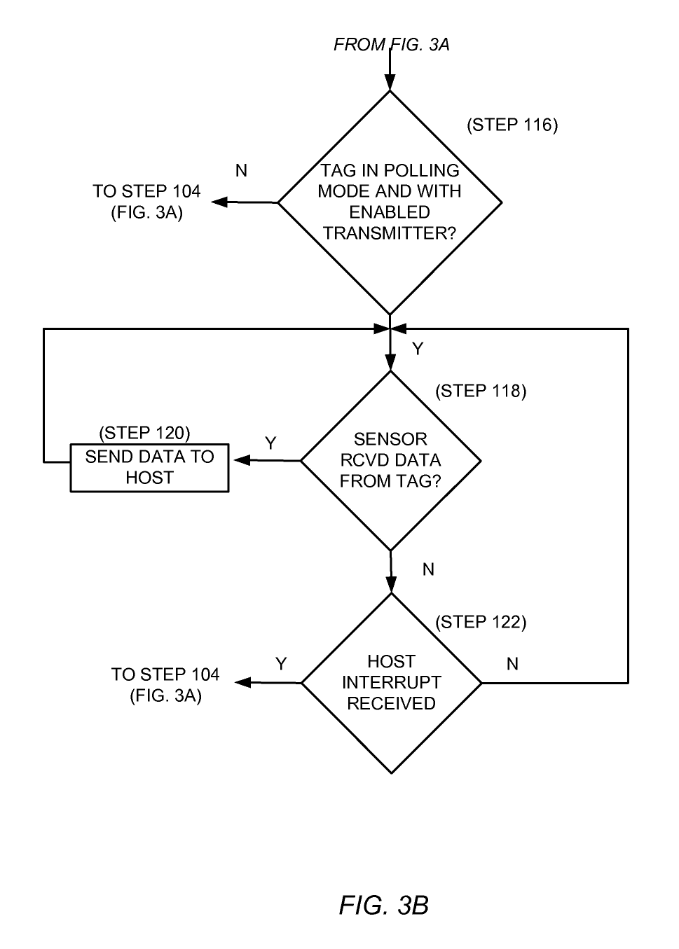

FIG. 3A and FIG. 3B show an embodiment of a process 100 performed by the transceiver module 14 during normal operation. This process 100 can be implemented in firmware of the transceiver module. After turning on, the transceiver module 14 initializes (step 102) the radio transceiver 52, LEDs, and its external communications transceiver 56 for communicating with the host device 12 through the communication link 22 (e.g., a USB or RS-232 connection). After initialization, the transceiver module awaits (step 104) receipt of a command from the host device. Table 1 provides examples of the types of command packets that the transceiver module 14 can receive from the host device 12.

TABLE 1

| Command Type | Usage/Purpose of Command | Data in Command |
|---|---|---|
| Beacon | To synchronize the RFID tag with the | The host's time in hours, |
| | host device. | minutes, and seconds |
| Poll all sensors | To cause RFID tag to poll all of its | N/A |
| | sensors, and to measure battery voltage. | |
| Poll Temperature | To cause RFID tag to poll specified | Bitmask in packet identifies |
| | temperature sensors. | which temperature sensors |
| | | to poll. |
| Poll Humidity | To cause RFID tag to poll specified | Bitmask in packet identifies |
| | humidity sensors. | which humidity sensors to |
| | | poll. |
| Poll Pressure | To cause RFID tag to poll specified | Bitmask in packet identifies |
| | pressure sensors. | which pressure sensors to |
| | | poll. |
| Change Setting | To change one of the RFID tag's | Identifies which setting to |
| | settings. | change, and provides a new |
| | | value for the setting. |
| Read Log Size | To determine how much sensor data is in | N/A |
| | the RFID tag's nonvolatile memory. This | |
| | information can then be used to start | |
| | reading the data out from the RFID tag's | |
| | log. | |
| Read Log | To read a block (25 bytes) from the | Two bytes identify log |
| | RFID tag's log in nonvolatile memory, | address to begin reading |
| | which contains sensor data and | from, a 3^{rd} byte identifies |
| | timestamps. | the number of bytes to read |
| | | (e.g., 25). |
| Check Battery | To cause RFID tag to measure its battery | N/A |
| | voltage. | |
| Get ID | To cause RFID tag to send its address. | N/A |
| Request | To request association within a pre- | N/A |
| Association | existing network of tags. | |
| Clear Log | To cause RFID tag to clear its log so that | N/A |
| | space is made for new sensor data to be | |
| | stored to RFID tag's nonvolatile | |
| | memory. | |
| Get Tag time | To cause RFID tag to send back its | N/A |
| | current timestamp. Can be used to | |
| | confirm synchronization between host | |
| | device and RFID tag. | |
| Enable Interval | To cause RFID tag to start polling and | N/A |
| Polling Mode | logging and possibly reporting measured | |
| | sensor data | |
| Disable Interval | To cause RFID tag to stop polling | N/A |
| Polling Mode | | |
| Change Polling | To change the polling interval | Identifies polling interval |
| Interval | | |
| Put Tag in Loud | To cause the RFID tag to transmit | N/A |
| Mode | measured sensor data (Transmitter | |
| | enabled) | |
| Put Tag is Silent | To cause the RFID tag to log sensor data | N/A |
| Mode | without transmission (Transmitter | |
| | disabled) | |

When the user of the host device selects a command to send to an RFID tag, the software application running on the host devices passes a command number to the transceiver module. Based on that number, the transceiver module 14 creates (step 106) a command packet and transmits (step 108) the command packet to the RFID tag 20 by radio transmission. After transmitting the command packet, the transceiver module listens (step 110) for a response from the RFID tag for a predetermined period (e.g., 1 second). If, after the predetermined period expires, the transceiver module has not yet received a response, the transceiver module sends (step 112) a message to the host device reporting the lack of the response. If, instead, a response is received during the predetermined period, the transceiver module forwards (step 114) that response to the host device 12.

At step 116 (FIG. 3B), the transceiver module returns to waiting for a command (step 104, FIG. 3A) from the host device if the RFID tag is not presently in polling mode and with an enabled transmitter. When the RFID tag is in the polling mode and has an enabled transmitter, the transceiver module 14 listens (step 118) for sensor data from the RFID tag. If sensor data is received from the RFID tag, the transceiver module sends (step 120) the data to the host device. Alternatively, the transceiver module continues listening for sensor data from the RFID tag. If, while listening, the transceiver module receives (step 122) a host interrupt, the transceiver module returns (step 104) to waiting for a command from the host device.

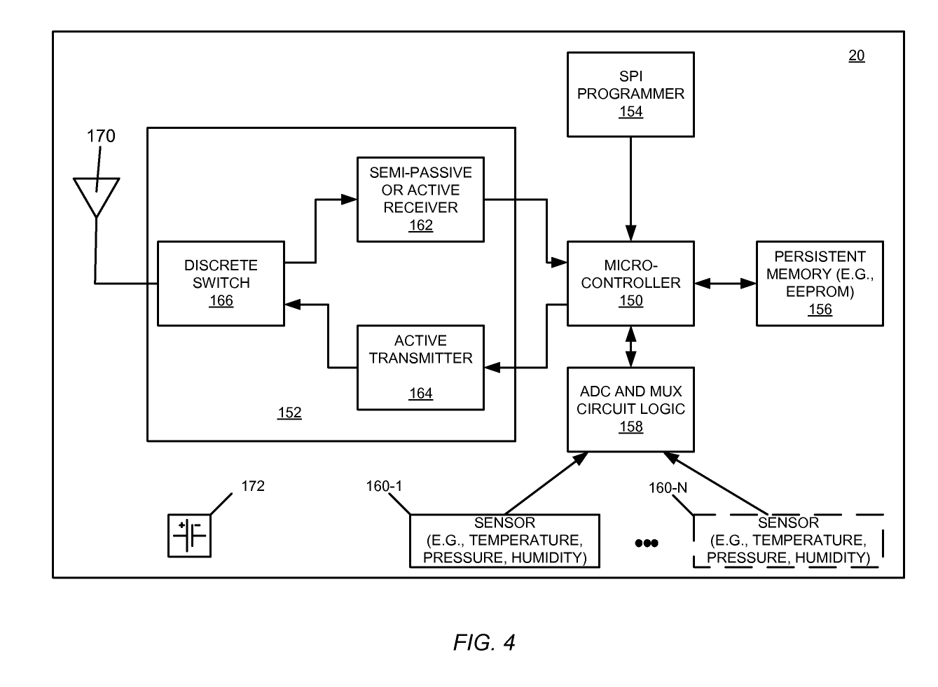

FIG. 4 shows a functional block diagram of one embodiment of the RFID tag 20, including a microcontroller 150 in communication with a radio transceiver 152, an SPI programmer 154, nonvolatile memory 156, and an analog-to-digital converter (ADC) and multiplexer circuit logic 158 (or ADC 158, for short). The ADC 158 is used to acquire measurements from the sensors 160-1, 160-n (generally, 160).

In one embodiment, the radio transceiver 152 includes a semi-passive receiver 162 and an active transmitter 164 in communication with a discrete switch 166 for switching between the radio transceiver's receive and transmit modes of operation. The discrete switch 166 enables shared use of a single antenna 170 within the RFID tag, data entering and leaving the radio transceiver over a single radio data line. The semi-passive receiver 162 is based on a diode detector circuit, used in RFID tags. A combination of PN-junction diodes and Schottky diodes gives the receiver 162 its diode detector functionality over the temperature range. The Schottky diodes work as the diode detectors at low temperatures where the PN-junction diodes are less effective, and the PN-junction diodes work at the high temperatures, where the Schottky diodes are less effective. The receiver 162 also has low power amplifying elements (consuming several microwatts each) to boost sensitivity.

In another embodiment, an active receiver is used instead of a semi-passive receiver. The active receiver is more sensitive than a semi-passive receiver for acquiring radio signals. To lower the average amount of power consumed, the active receiver is operated with a low duty cycle.

Data reception entails setting the radio transceiver 152 to receive mode and polling the data line until either a timeout period expires (if a timeout is specified) or a packet is received. In one embodiment, Manchester coding is used. In Manchester coding, information is contained in the bit transitions, so the packet has an equal number of “on” and “off” states. The average value of the packet is therefore a good choice for the threshold between “on” and “off.” This allows for a particularly simple implementation of a semi-passive OOK receiver.

All circuitry in the tag 20 relies on an internal battery 172 for power. The battery can be a TLH-5902/P +3.6V, 900 mAh lithium cell battery from Tadiran Batteries of Lake Success, N.Y. Lithium batteries have very good energy density, but suffer from anode passivation layer. Growth of this passivation layer occurs during long-term storage, but can be greatly accelerated by high temperatures. The passivation layer increases the battery's internal resistance. To compensate for this increased internal resistance, a large capacitor bank is connected in parallel with the battery. The capacitor bank reduces the effective internal resistance during short current bursts. Passivation can be prevented in storage by having the tag periodically wake up and draw a small amount of current, which breaks up the passivation layer. Depending upon a particular embodiment of the RFID tag, the battery 172 can be rechargeable or non-rechargeable, removable and replaceable, or irremovable and disposable.

In one embodiment, the radio transmitter 64 in the transceiver 152 can be implemented using a MICRF405 produced by Micrel Inc of San Jose, Calif. This device generates a typical transmit power of +10 dBm into a 50-ohm load in the UHF band. In addition, the internal antenna 170 can be implemented with a 915 MHz Splatch PCB (printed circuit board) antenna from Linx Technologies of Merlin, Oreg.

The microcontroller 150 operates from an internal 8 MHz RC oscillator and interfaces with all of the sensors (both digital and analog), the radio transceiver 152, and the memory 156, as described herein. Programming of the microcontroller 150 is accomplished using a SPI programmer 154. In one embodiment, the microcontroller 150 is implemented with an ATMEGA644P automotive microcontroller from Atmel. Components designed for automotive applications have excellent performance at high temperatures.

The nonvolatile memory 156 stores data acquired by each sensor 160. Data stored in the nonvolatile memory 156 persists through a power cycle of the RFID tag. In one embodiment, the nonvolatile memory 156 is implemented with a 128 Kb 24LC1025 EEPROM from Microchip Technology, Inc. Logging occurs periodically and can be used to prevent the loss of data, even in the event of communication problems. Each data log entry of sensor data includes a timestamp of when the sensor reading occurred.

The RFID tag 20 also includes a low power, slow oscillator (not shown). In one embodiment, this is implemented with the EM7604, produced by EM Microelectronics of Marin, Switzerland. Consuming less than a microwatt, the oscillator can be kept running continuously during tag operation, serving to activate those high power-consuming electronic components only when the use of such electronics becomes necessary. For example, the oscillator wakes up the microcontroller periodically to make a measurement or to transmit data. The oscillator can also be used as a real time clock, keeping track of the current hour, minute, and seconds.

The RFID tag 20 includes one or more sensors 160. Examples of types of the sensor 160 include, but are not limited to, temperature sensors, pressure sensors, humidity sensors, chemical sensors, and any combination thereof. The RFID tag 20 can have multiple sensors of the same type to provide redundancy, for example, three temperature sensors. Other embodiments can have multiple sensors of different types, for example, a temperature sensor, a pressure sensor, and a humidity sensor.

Temperature sensors can be implemented with the hermetically sealed high temperature silicon sensors KTY83 from NXP of Eindhoven, Netherlands. These sensors have an operating range of −55 to 175° C.

Humidity sensors can be implemented with a capacitive humidity sensor, such as HS1101LF or HTS2030SMD from Humeril, which have an operating temperature range of −60 to 140° C. Capacitive humidity sensors can experience problems in high humidity environments, such as steam sterilizers, because these sensors absorb moisture. The slow release of moisture affects the measurements of the sensors, resulting in unpredictable drift. Other non-capacitive sensors can used for these high humidity applications.

Pressure sensors can be implemented with an SM5420-100-A-P pressure sensor from Silicon Microstructures of Milpitas, Calif. This sensor provides a full-scale pressure reading of up to 100 psi. Sensors with analog outputs can be read using a single high-resolution ADC (analog to digital converter) by using a multiplexor, which selects one channel at a time to be digitized. In one embodiment, the ADC is implemented using the 22-bit MCP3553 produced by Microchip Technology of Chandler, Ariz. This ADC can make accurate readings with a direct connection to a sensor, so costly precision amplifiers and resistors can be avoided.

The RFID tag 20 has a mode of operation wherein the RFID tag polls all of its sensors 160 at a predefined interval. The RFID tag supports a variable programmable interval. One example of a predefined default interval is 1 second. When the RFID tag enters this mode, called the “Interval Polling” mode, by default the RFID polls all of its sensors every second. The host device can then send subsequent commands, for example to change the polling period, take the RFID tag out of Interval Polling mode, or change the sensors polled.

The RFID tag 20 also has two polling modes when placed into the Interval Polling mode: a “Loud” mode, and a “Silent” mode. When in the Loud mode, the RFID tag 20 logs the acquired sensor data to the nonvolatile memory with a timestamp and transmits the sensor data back to the host device over the radio link 22. Accordingly, the host device is able to acquire the sensor data in real-time (i.e., the current conditions of the environment being monitored). In contrast, when in the Silent mode, the RFID tag 20 only logs the sensor data to the nonvolatile memory with a timestamp. The default polling mode is Silent. To enter the Loud mode, the RFID tag needs to receive an explicit command from the host device (through the transceiver module), placing the RFID tag into the Loud mode. Upon issuing this command, the host device can begin receiving packets with sensor data periodically transmitted by the RFID tag over the radio link.

Because it relies on battery power, an RFID tag can function normally for as long as its battery can supply sufficient power. In those embodiments where the battery is irremovable, the RFID tag is discarded when the battery dies. In this instance, the life of the battery limits the life of the RFID tag. To extend the useful life of the RFID tag, the various components within the RFID tag are designed to consume low power on average.

Most of the power consumed by the RFID tag occurs when waiting for the arrival of command from the host device, during data transmission, and during data measurement. While waiting for a command, all components of the RFID tag consume low amount of power (“sleep” mode). In the embodiment with the semi-passive receiver, the semi-passive receiver is operating at all times, and wakes up the microcontroller in response to detecting the start of a packet. If a packet is received, the RFID tag executes the required command. In the embodiment with the active receiver, which operates with a low duty cycle (e.g., on for 10 ms of every second). In this case, the command packet is sent multiple times throughout a one-second period. The active receiver will ignore most of the packets because it will be off at the time of the packets' transmission. One or more of the packets will arrive while the active receiver is awake, and thus successfully received. Again, the required command is then executed. Other mechanisms for waking up the tag without the need for an external switch can be used, including magnetic reed switches and accelerometers.

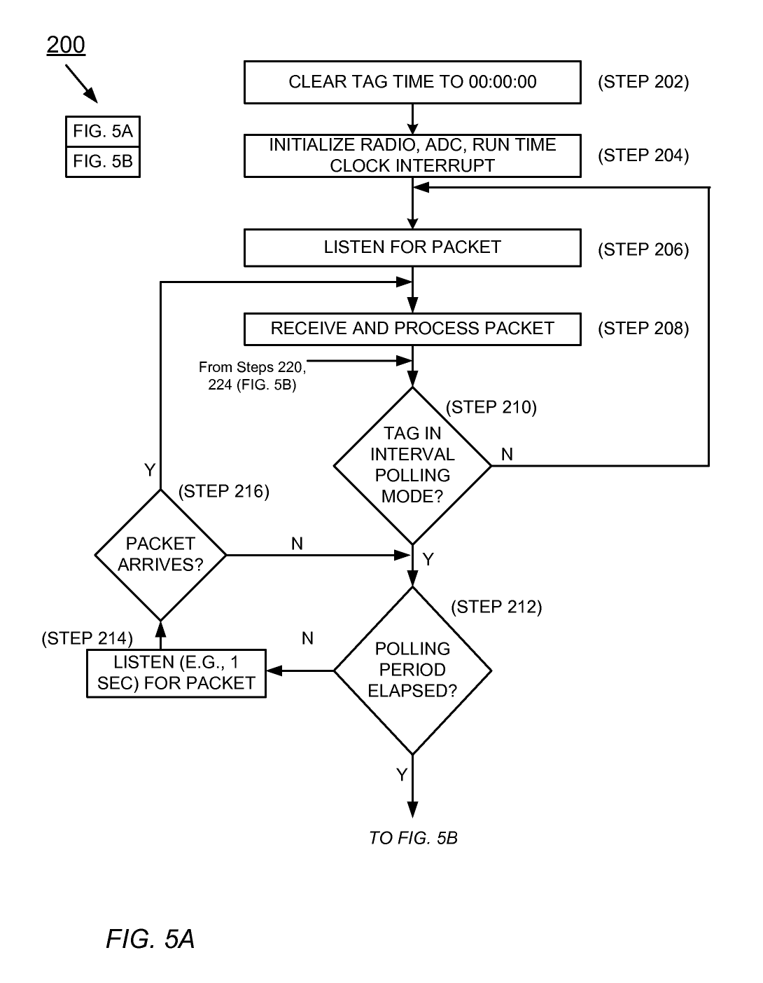

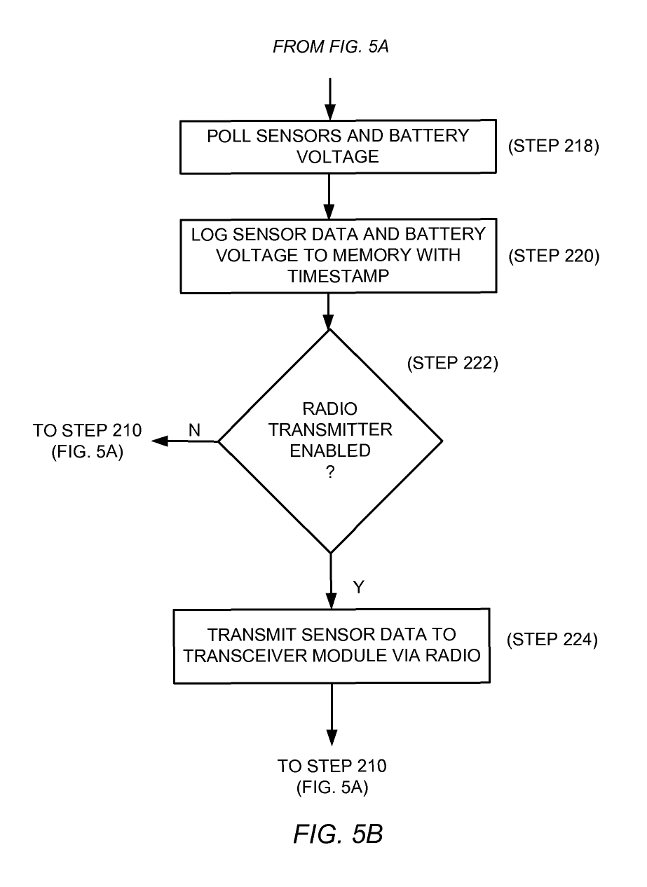

FIG. 5A and FIG. 5B show an embodiment of a process 200 performed by the RFID tag 20 during normal operation. This process 200 can be implemented in firmware of the RFID tag. When the RFID tag 20 first powers on, time of the RFID tag can be reset (step 202) to zero hours, minutes, and seconds. The radio transceiver 152, ADC 158, and run time clock interrupt initialize (step 204). The RFID tag 20 then loops (step 206), listening and waiting for a packet to arrive over the radio.

Upon receiving a packet, the RFID tag 20 processes (step 208) the packet in accordance with the type of command that the packet conveys. An example set of commands is shown in Table 2.

TABLE 2

| Response Type | Usage | Data |
|---|---|---|
| ACK | Sent after receiving a Beacon command | N/A |
| (Acknowledge) | packet | |
| Poll all sensors | Sent after receiving a “Poll all sensors” | Temperature, humidity, |
| | command packet. | pressure, battery voltage. |
| Poll Temperature | Sent after receiving a “Poll temperature” | Bitmask identifies which |
| | command packet | temperature sensors were |
| | | polled, and the temperature |
| | | reading from each specified |
| | | sensor. |
| Poll Humidity | Sent after receiving a “Poll humidity” | Bitmask identifies which |
| | command packet | humidity sensors were |
| | | polled, and the humidity |
| | | reading from each specified |
| | | sensor. |
| Poll Pressure | Sent after receiving a “Poll pressure” | Bitmask identifies which |
| | command packet | pressure sensors were |
| | | polled, and the pressure |
| | | reading from each specified |
| | | sensor. |
| Change Setting | Sent after receiving a “Change setting” | N/A |
| | command packet | |
| Read Log Size | Sent after receiving a “Read log size” | Size of log |
| | command packet | |
| Read Log | Sent after receiving a “Read log” | Number of bytes read, |
| | command packet | timestamp, sensor data in |
| | | entry. |
| Check Battery | Sent after receiving a “Check battery” | Battery voltage |
| | command packet | |
| Get ID | Sent after receiving a “Get ID” | Address of the tag |
| | command packet | |
| Clear Log | Sent after receiving a “Clear log” | N/A |
| | command packet; clears the sensor data | |
| | log by writing 0 to the log size field | |
| | stored in the memory | |
| Get Tag time | Sent after receiving a “Get tag time” | Tag hour, minute, and |
| | command packet | second |
| Enable Interval | Sent after receiving a “Enable Interval | N/A |
| Polling Mode | Polling mode” command packet | |
| Disable Interval | Sent after receiving a “Disable Interval | N/A |
| Polling Mode | Polling mode” command packet | |
| Change Polling | Sent after receiving a “Change Polling | Identifies polling interval |
| Interval | Interval” command packet | |
| Put Tag in Loud | Sent after receiving a “put tag in Loud | N/A |
| Mode | mode” command packet | |
| Put Tag is Silent | Sent after receiving a “put tag in Silent | N/A |
| Mode | mode” command packet | |

The RFID tag continues listening, receiving, and processing packets until a received command places the RFID tag into the Interval Polling mode. When, at step 210, the command in the packet puts the RFID tag into the Interval Polling mode, then the RFID tag checks (step 212) whether the polling interval has elapsed. If the polling interval has not yet elapsed, the RFID tag listens (step 214) for the arrival of a packet. The RFID tag may listen for a predefined period (e.g., 1 sec). If a packet arrives (step 216) at the RFID tag during this period, the RFID tag then processes (step 208) the packet, provided the packet is a valid command. The RFID tag performs the action requested by the command; as a result, depending upon the particular command, the RFID tag may exit the Interval Polling mode, request certain information, change a setting, and so on.

Provided the RFID tag remains in the Interval Polling mode, when the polling interval elapses, the RFID tag begins polling (step 218, FIG. 5B) all of its sensors and the battery voltage at the default polling interval (unless a previously received command changed the polling target or the duration of the default polling interval). The RFID tag, whether in Silent mode or in the Loud mode, logs (step 220) the sensor data and battery voltage to the nonvolatile memory 156 with a timestamp. When the radio transmitter is not enabled (i.e., Silent mode), the RFID tag returns (step 222) to checking whether it is still in the Interval Polling mode. When the radio transmitter is enabled (i.e., Loud mode), the RFID tag transmits (step 224) the sensor data and battery voltage to the transceiver module via the radio.

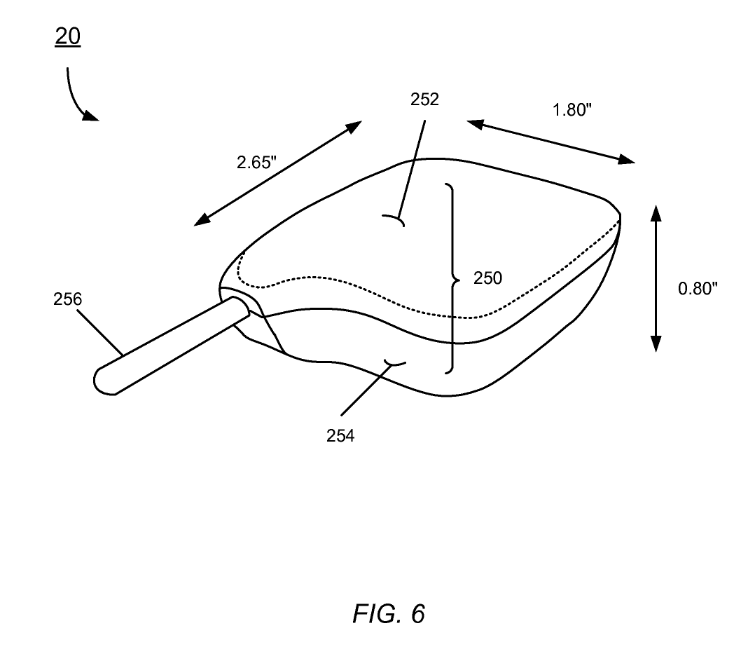

FIG. 6 shows an isometric view of one embodiment of an RFID tag 20. The RFID tag 20 includes a plastic housing 250 (e.g., Ultem) comprised of a lid 252 and a base 254. The plastic material of the plastic housing 250 is resistant to water absorption and to elevated temperatures. In one embodiment, the plastic housing is a Polyetherimide (e.g., Ultem) product having a glass temperature of 210° C., water absorption of 0.25%, and water absorption saturation of 1.25%.

A temperature probe 256 projects through an opening in one side of the RFID tag 20. In one embodiment, the RFID tag 20 has a height of 0.80 inches, a width of 1.80 inches, and a length (excluding the temperature probe) of 2.65 inches, and the temperature probe has an outer diameter of ⅛ inches. The length of the temperature probe is determined by the lead length. Depending upon the particular application, the extension of the leads outside of the tag housing can range from 1 to 24 inches. Other lead lengths can be used without departing from the principles described herein. Lead lengths at the longer end of the range can be used to extend the temperature probe inside long, narrow lumens.

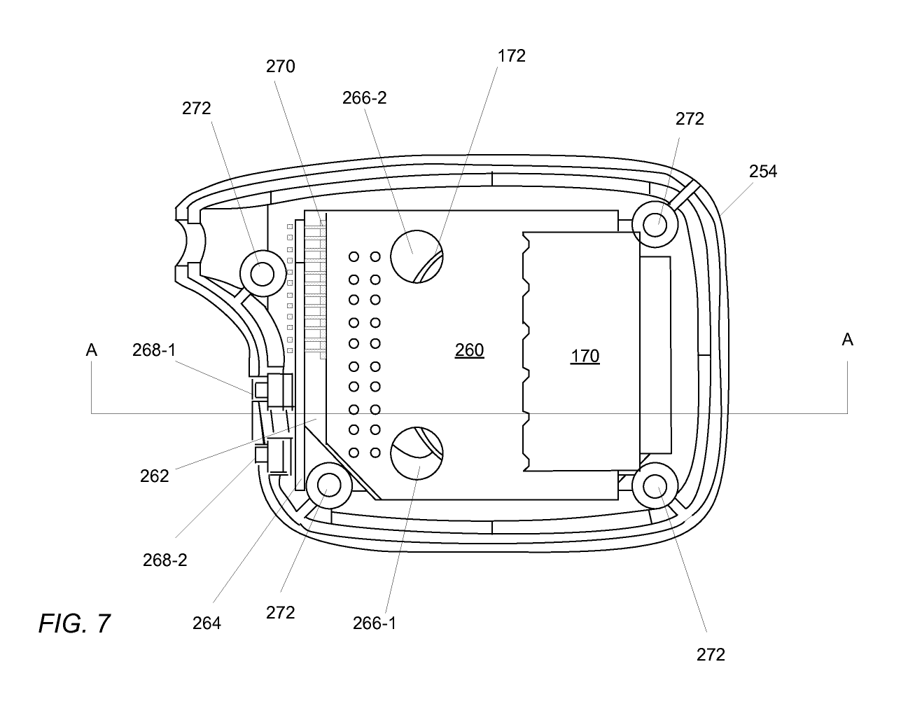

FIG. 7 shows a top view of the base 254 of the RFID tag housing 250, without the lid 252 and temperature probe 256 of FIG. 6, exposing various internal components. Shown are an upper printed circuit board 260 referred to as a communications board, a lower printed circuit board 262 referred to as a processing board, and the side edge of side printed circuit board 264 referred to as a sensor board. On the communication board 260 is the internal antenna 170 and circuitry of the radio transceiver 152 (not shown).

To decrease the size of the RFID tag further, in one embodiment the temperature probe which extends from the housing has a dual-role as the antenna. In general, an antenna used for low frequencies is often one of the largest components on the circuit board, and accordingly occupies a commensurate amount of area. Combining the temperature probe with the antenna is possible because the temperature measurement and communication functions use different frequency bands, and, thus, do not interfere with each other. In addition, the user can bend the temperature probe into arbitrary shapes. To keep the properties of the antenna somewhat constant, only the part of the temperature probe housed within the RFID tag is used as the antenna.

The communication board 260 also has a pair of holes 266-1, 266-2 (generally, 266), for extruding epoxy as described further below. Visible within the holes 266 is the edge of the battery 172, which is disposed on the processing board 262. Although not shown, also on the processing board 262 are the microcontroller 150, nonvolatile memory 156, and the circuitry of the ADC 158. The arrangement of the boards within the housing 250 is designed to expose the sensor board 264 to the physical surroundings (i.e., the harsh environment), while providing a measure of protection to the communication board 260 and the processing board 262.

Electrically connected to the sensor board are other sensor components 268-1, 268-2 (generally, 268). The sensing portion of the sensor components 268 pokes through openings in the side of the RFID tag housing 250. These sensor components 268 are for sensing humidity and pressure near the RFID tag. An electrical connector 270 couples the sensor board 264 to the processing board 262. Holes 272 disposed generally in the corners of the base 254 are for corresponding pins of the lid to enter into and snap.

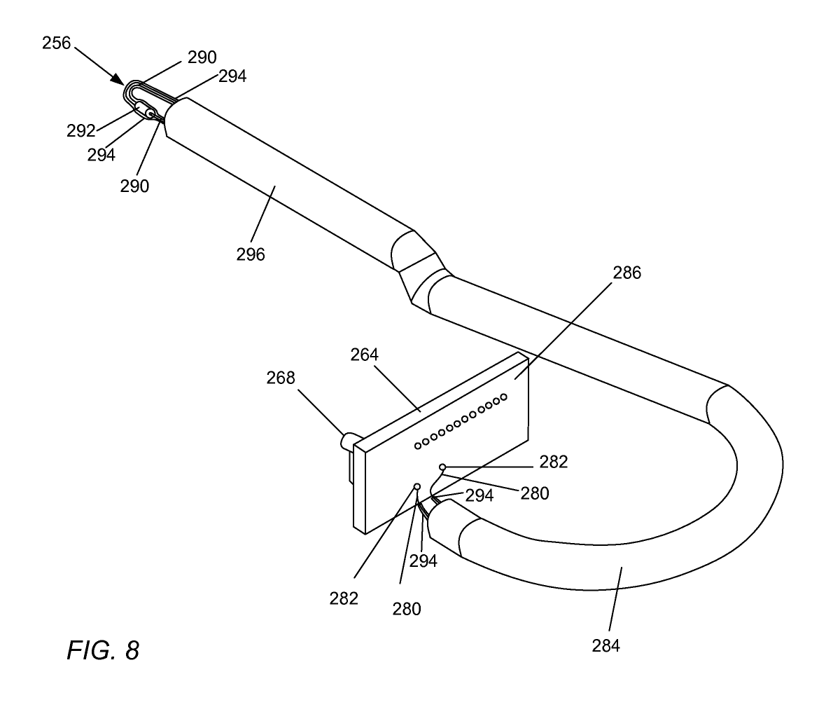

FIG. 8 shows an embodiment of the temperature probe 256 with its leads 280 electrically connected to electrically conductive through-holes 282 on one side of the sensor board 264. In one embodiment, the leads are made of KOVAR™ wires that are spot welded to the leads 290 of the KTY83 silicon thermistor 292, wrapped once from end to end (except a small portion of the leads 280 which remain exposed for making electrical connection to the sensor board 264) in a heat-shrunk PTFE (polytetrafluoroethylene) sleeve 294 to provide a moisture bather and to prevent a vapor region around the leads, and wrapped again with a second PTFE sleeve 296 after the temperature probe 256 is bent double over. The PTFE shrink-wrapped leads are wrapped around the board 260 before being attached to the sensor board 264 and before potting, to provide strain relief. Special plasma treating or roughening of the PTFE can be used to facilitate bonding to the epoxy if necessary.

The temperature probe 256 has a flexible section 284 that enables it to be bent around the battery 172 and processing board 262 (not shown) and to fit over the beveled edge 286 of the sensor board 264. The temperature probe 256 retains the shape into which it is bent. The temperature probe is coupled to the sensor board, the processor board, or on a combination thereof (e.g., for measurement comparison).

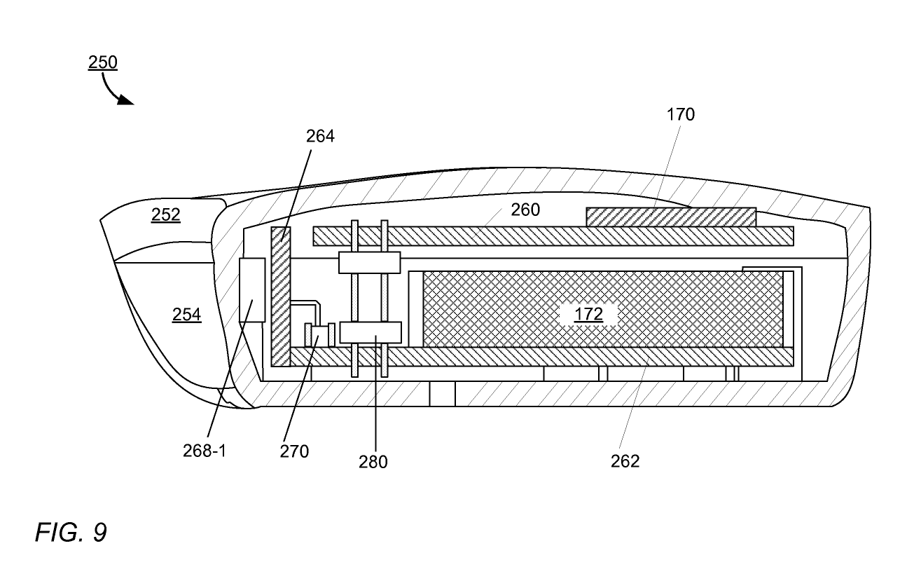

FIG. 9 shows a cross-section of the RFID tag 20 taken along line A-A in FIG. 7. Electrical connectors 280 electrically connected the communication board 260 having the internal antenna 170 to the processing board 262 with the battery 172. The connector 270 physically and electrically connects the sensor board 264 to the processing board 262.

### Packaging

Packaging of the RFID tag is an important consideration for cost and durability. A steam sterilizer chamber, as an example, presents a harsh environment for the RFID tag, and can render it unreliable or nonfunctional if water reaches its internal electronics. In general, even a high-quality seal around a probe projecting from the housing of the RFID tag may yield to the combination of thermal cycling and high-pressure steam and permit moisture ingress. As a safeguard against such ingress, the various components housed within the RFID tag, including the antenna, the printed circuit boards, and battery, are potted in their entirety within a high-temperature epoxy. A silicone sleeve can be placed around the battery to mitigate the battery's thermal expansion. Accordingly, any moisture penetrating the seal around the probe must further penetrate a thick layer of epoxy, and do so in large enough quantities, to damage the internal electronics.

In addition, the particular epoxy used to encapsulate the components has a coefficient of thermal expansion that approximately matches that of the internal printed circuit boards and the plastic housing, if used. The approximate matching of thermal coefficients serves to minimize cracking at the places where plastic, circuit board, and epoxy meet.

In one embodiment, the epoxy is EP62-1MED manufactured by Master Bond, Inc. of Hackensack, N.J. This epoxy has glass and deflection temperatures of at least 150° C. The coefficient of thermal expansion for this epoxy is 35-40 μm/m-° C. Fillers can be added to adjust the CTE to better match the components and housing. The plastic housing (ULTEM) has a coefficient of thermal expansion of 55.0 μm/m-° C., and the circuit boards (370HR laminate) have a coefficient of thermal expansion of 50 μm/m-° C. along the z-axis and 15 μm/m-° C. along the x and y axes. Radel® R-5000 is another plastic that can be used for a housing material, having a glass temperature of 220° C., a deflection temperature of 214° C. at 66 psi, or 207° C. at 264 psi, and a CTE of 56 μm/m-° C. It is to be understood that the matching of coefficients, as used herein, does not mean an exact match; rather, an approximate match wherein the matching coefficients are similar enough to prevent stress and strain related to mismatched growth of the various components.

Advantageously, the plastic housing and epoxy surrounding the antenna produces little or no impediment to the propagation of electromagnetic radiation. In addition, the placement of the antenna 170 near or against a surface of the plastic housing 250 (FIG. 7) limits the amount of epoxy that can surround the antenna, which contributes to the ability of the antenna to transmit and receive radio signals through the housing and epoxy. Low dissipation factors for the plastic material and epoxies are also beneficial.

To facilitate radio communications further, the particular epoxy used to encapsulate the components and the outer housing have a dielectric constant close to 1. For example, the EP62-1MED epoxy has a dielectric constant of 3.7, and the Ultem plastic housing has a dielectric constant of 3.15.

The EP62-1MED epoxy is but one example of an epoxy that can be used to pot the interior components of the plastic housing. Another epoxy that can be used, having similar thermal and dielectric properties as the EP62-1MED epoxy, is Master Bond's EP42HT-2 (coefficient of thermal expansion of 35-40 μm/m-° C.; dielectric constant of 3.8).

### Potting Process

When potting the RFID tag, pre-cleaning the various components in an isopropyl alcohol bath and/or pre-treating with a plasma process improves adhesion of the epoxy to the components and reduces the possibility of void formation. During the potting process, the sensor ports are masked and latex tape is placed over the seam between the lid and the base to prevent leakage. Holes in the circuit boards facilitate the flow of the epoxy throughout the RFID tag. Methods to prevent trapped air bubbles while curing should be employed, for example, by potting under vacuum or with vibration. The epoxy preferably has a set time that is long enough to allow bubbles to escape before getting trapped in the cured epoxy. After the epoxy sets, the epoxy is topped off to accommodate any shrinkage that results from setting. The cure temperature is preferably lower than any desired operating temperatures for the device.

### Communication

The harsh operating environment and power limitation of the RFID tag can pose problems to reliable communication. The chamber, being an enclosed metal cavity, can have many regions where signal reception is particularly weak, regions referred to as nulls. Further, the moisture, steam, and metal objects in the chamber can attenuate electromagnetic radiation.

To improve the reliability of communications, the environment monitoring system can employ various mechanisms including, but not limited to, placing the antenna 18 within the chamber, using relatively low data rates, and frequency hopping to avoid nulls. Another mechanism employs a protocol that verifies packet delivery. Inevitably, some packets are lost due to noise and sporadic interference. By assigning each packet a unique identification number, the transceiver module can verify whether it has received every packet transmitted by an RFID tag and can request the RFID tag to resend those packets that are lost.

### Multi-Tag Operation

Often environment monitoring systems concurrently deploy multiple RFID tags in the environmental chamber and integrate their sensor data readings. Obtaining real-time sensor measurements from all of the RFID tags in a chamber becomes a problem if all RFID tags are broadcasting at the same time. To avoid interference among the RFID tags, the transceiver module 14 uses the wireless radio communication links 26 (FIG. 1) to synchronize the RFID tags 20 and to manage when each RFID tag transmits.

An embodiment of a process for globally managing RF transmissions from multiple RFID tags placed within a monitored environment entails uniquely assigning a timeslot to each RFID tag. Only one RFID tag transmits during its designated timeslot, thus avoiding interference. The transceiver module 14, serving as a controller, sends a synchronization packet once per second. The RFIDs tags have an internal clock, but because the RFID tag preferably consumes low power and is also exposed to extreme temperature swings, the internal clock may drift significantly over time. The synchronization packet keeps the internal clocks of all the RFID tags synchronized, which, in turn, guarantees that none of the timeslots allotted to the RFID tags overlap (called a collision).

Another method for globally managing RF transmissions from multiple RFID tags is for each RFID tag to transmit its data during a random timeslot, resending the same data during several transmissions. If the timeslot is changed after each transmission, then collisions between any two transmitting RFID tags are uncorrelated. If there are a sufficient number of timeslots, the probability of several consecutive collisions becomes small. An advantage of this method is to forego any need to synchronize the tags; data can be collected in real time even if downlink communication is not possible. A possible disadvantage is that as the number of RFID tags and frequency of data collection increases, the probability of a collision can increase to inefficient levels.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects. All such forms may be generally referred to herein as a “system.” Furthermore, aspects of the present invention may take the form of a computer program product embodied in one or more computer readable storage medium(s) having computer readable program code embodied thereon.

A computer readable storage medium may be any tangible medium that can contain, or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium include, but are not limited to, the following: a portable computer diskette, a hard disk, a random access memory (RAM), a read-only memory (ROM), an erasable programmable read-only memory (EEPROM, EPROM, Flash memory), an optical fiber, a portable compact disc read-only memory (CD-ROM), an optical storage device, a magnetic storage device, or any suitable combination of the foregoing. Program code embodied on a computer readable storage medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Aspects of the present invention are described herein with reference to flowchart illustrations and block diagrams of methods, apparatus (systems), and computer program products in accordance with embodiments of the invention. Each block of the flowchart illustrations and block diagrams, and combinations of blocks in the flowchart illustrations and block diagrams can be implemented by computer program instructions.

Computer program instructions may be provided to a processor of a general purpose computer, special purpose computer, or other programmable data processing apparatus to produce a machine, such that the instructions, which execute via the processor of the computer or other programmable data processing apparatus, create means for implementing the functions, acts, or operations specified in the flowchart and block diagram block. Computer program instructions may also be stored in a computer readable storage medium that can direct a computer, other programmable data processing apparatus, or other devices to function in a particular manner, such that the instructions stored in the computer readable medium produce an article of manufacture including instructions which implement the function, act, or operation specified in the flowchart and block diagram block.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions, acts, or operations specified in the flowchart or diagram block.

The flowchart and block diagrams in the FIGS. illustrate the architecture, functionality, and operation of possible implementations of systems, methods, and computer program products according to various embodiments of the present invention. In this regard, each block in the flowchart or block diagrams may represent a module, segment, or portion of program code, which comprises one or more executable instructions for implementing the specified logical function(s). The functions noted in the blocks may occur out of the order noted in the FIGS. For example, two blocks shown in succession may be executed substantially concurrently, or the blocks may sometimes be executed in the reverse order, depending upon the functionality involved. In addition, each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A portable RFID (Radio Frequency Identification) tag, comprising:
one or more sensors, each sensor measuring a condition of an environment within which the RFID tag is disposed;
circuitry obtaining data from measurements provided by each sensor;
a transceiver modulating a radio frequency (RF) signal carrying the obtained data; and
an antenna, electrically coupled to the transceiver, transmitting the RF signal,
wherein the circuitry, transceiver, and antenna are potted in their entirety in a thermosetting plastic epoxy.

2. The RFID tag of claim 1, further comprising a housing made of a plastic material resistant to water absorption and to elevated temperatures, the housing being filled with the epoxy within which are potted the circuitry, transceiver, and antenna in their entirety.

3. The RFID tag of claim 2, wherein the epoxy has a thermal expansion coefficient that approximately matches a thermal expansion coefficient of the plastic material of the housing.

4. The RFID tag of claim 2, wherein the antenna is disposed adjacent an interior surface of the housing to limit an amount of epoxy that can surround the antenna.

5. The RFID tag of claim 2, wherein the epoxy has a dielectric property that approximately matches a dielectric property of the plastic material of the housing.

6. The RFID tag of claim 1, wherein the circuitry is disposed on one or more circuit boards, and the epoxy has a thermal expansion coefficient that approximately matches a thermal expansion coefficient of each circuit board.

7. The RFID tag of claim 1, further comprising a battery, fully potted in the epoxy, for supplying power to the circuitry and transceiver.

8. The RFID tag of claim 7, wherein the battery is enclosed in a silicone sleeve.

9. The RFID tag of claim 1, wherein the epoxy has a glass temperature and deflection temperature capable of enduring an elevated temperature at least as high as 140° C.

10. The RFID tag of claim 1, wherein the one or more sensors include a temperature probe that extends out of the epoxy into the environment in which the RFID tag is disposed.

11. The RFID tag of claim 10, wherein the temperature probe has leads that are shrink-wrapped in a fluoropolymer material to prevent vapor ingress to the leads.

12. The RFID tag of claim 1, wherein the one or more sensors include a temperature sensor, a pressure sensor, and a humidity sensor.

13. The RFID tag of claim 1, wherein the transceiver comprises a semi-passive receiver.

14. The RFID tag of claim 1, wherein the transceiver comprises an active receiver operated at a low duty cycle of 1% or less to manage power consumed by the active receiver.

15. A portable RFID (Radio Frequency Identification) tag, comprising:
a temperature probe measuring temperature in an environment within which the RFID tag is disposed;
circuitry in communication with the temperature probe to obtain temperature data from measurements provided by the temperature probe; and
a transceiver modulating a radio frequency (RF) signal carrying the temperature data obtained by the circuitry, the transceiver being in communication with the temperature probe to use a portion of the temperature probe as an antenna for transmitting the RF signal carrying the temperature data.

16. The RFID tag of claim 15, wherein the circuitry, transceiver, and that portion of the temperature probe used as the antenna are potted within a thermosetting plastic epoxy.

17. An environment monitoring system, comprising:
a chamber providing an enclosed environment;
a plurality of portable RFID (Radio Frequency Identification) tags disposed within the enclosed environment provided by the chamber, each RFID tag comprising:
one or more sensors, each sensor measuring a condition of an environment within which the RFID tag is disposed;
circuitry obtaining data from measurements provided by each sensor;
a transceiver modulating a radio frequency (RF) signal carrying the obtained data; and
an antenna, electrically coupled to the transceiver, transmitting the RF signal, wherein the circuitry, transceiver, and antenna are potted in their entirety in a thermosetting plastic epoxy; and
a transceiver module disposed outside of the chamber in communication with each of the RFID tags within the chamber to transmit thereto commands and to receive therefrom, in response to the commands, the transmitted RF signals carrying the obtained data.

18. The environment monitoring system of claim 17, further comprising a shared antenna disposed within the chamber for exchanging radio communications between the transceiver module and each RFID tag.

19. The environment monitoring system of claim 17, further comprising a host device in communication with the transceiver module, the host device issuing commands to the RFID tags and receiving data obtained by the RFID tags through the transceiver module.

20. The environment monitoring system of claim 17, wherein one of the sensors in each RFID tag is a temperature probe and a portion of a temperature probe operates as the antenna of that RFID tag.

21. The environment monitoring system of claim 17, further comprising a battery fully potted in the epoxy with the circuitry, transceiver, and antenna, for supplying power to the circuitry and transceiver.
